(19) United States
(12) Patent Application Publication
(10) Pub. No.: US 2024/0420001 A1
(43) Pub. Date: Dec. 19, 2024

(54) MULTIPLEXED FLUX CONTROL AND READOUT OF A COUPLER QUBIT

(71) Applicant: International Business Machines Corporation, Armonk, NY (US)

(72) Inventors: MUIR KUMPH, Croton on Hudson, NY (US); JOHN BLAIR, Katonah, NY (US)

(21) Appl. No.: 18/334,103

(22) Filed: Jun. 13, 2023

(51) Int. Cl. G06N 10/40; H01P 1/38

(52) U.S. Cl. CPC G06N 10/40; H01P 1/38

(57) ABSTRACT

One or more systems, devices and/or computer-implemented methods of use provided herein relate to single-device readout of the state of a coupler qubit and flux control of that coupler qubit, which processes can be performed simultaneously. In one or more embodiments, an electronic system comprises a coupler qubit, a pair of superconducting qubits coupled to the coupler qubit, a multiplexed input line, and a readout and flux control subsystem coupled between the multiplexed input line and the coupler qubit, wherein the readout and flux control subsystem is configured to allow for both readout of a state of the coupler qubit and flux control that adjusts a coupling between the pair of superconducting qubits. The diplexer couples together the readout resonator and a flux control portion of the electronic system, wherein the readout resonator and the flux control portion are separated from one another between the diplexer and the coupler qubit.

### TECHNICAL FIELD

The present disclosure relates to single-device control of readout and flux control of a coupler qubit, and more specifically to single-device performance of such processes by diplexed portions of a multiplexed electronic structure.

### BACKGROUND

In quantum computing systems, a data qubit of a quantum processor can receive a signal that can allow for readout of a state of that data qubit. Also in quantum computing systems, a pair of qubits, such as superconducting qubits, can be coupled to one another such that a coupler between the pair of qubits, and providing the coupling, can be flux controlled to adjust for operation between the pair of qubits.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, electronic systems, electronic structures, computer-implemented methods and/or computer program products can provide a process to allow for single-device control of readout and flux control of a coupler qubit coupled to qubits of a quantum processor.

In accordance with an embodiment, an electronic structure can comprise an input line electrically coupled to a first coupler and a second coupler, a flux-controlled qubit comprising a flux element, the first coupler electrically coupled to a pad of the flux-controlled qubit, and the second coupler electrically coupled to the flux element of the flux-controlled qubit.

In accordance with another embodiment, an electronic system can comprise electronic system can comprise a multiplexed input line, and a readout and flux control subsystem coupled between the multiplexed input line and the coupler qubit, wherein the readout and flux control subsystem is configured to allow for both readout of a state of a coupler qubit and flux control of the coupler qubit.

In accordance with yet another embodiment, an electronic system can comprise a coupler qubit, a pair of superconducting qubits coupled to the coupler qubit, a multiplexed input line, and a readout and flux control subsystem coupled between the multiplexed input line and the coupler qubit, wherein the readout and flux control subsystem is configured to allow for both readout of a state of the coupler qubit and flux control that adjusts a coupling between the pair of superconducting qubits.

An advantage of any one or more of the above-indicated embodiments can be an ability to both provide for qubit readout and qubit flux control with a single device. In one or more cases, where applicable, these processes can be performed simultaneously. By providing both processes with a single electronic structure, valuable real estate can be saved in a cryogenic environment where this electronic structure is located, along with the physical qubits of a quantum processor. That is, a single electronic structure can provide both the qubit readout and the qubit flux control. A single input line can then be used for both the qubit readout and the qubit flux control, allowing for reduced wiring into a cryogenic environment, where wires and couplers take up valuable real estate. As used herein, the “qubit” can refer to a qubit serving as both a data qubit and a coupler, e.g., a coupler qubit.

### DESCRIPTION OF THE DRAWINGS

FIG. 1 illustrates a block diagram of a non-limiting quantum system that can operate on one or more qubits, in accordance with one or more embodiments described herein.

FIG. 2 illustrates a block diagram of a non-limiting electronic structure that con be employed at the quantum system of FIG. 1 to provide both readout control and flux control for a coupler qubit of the quantum system of FIG. 1, in accordance with one or more embodiments described herein.

FIG. 3 illustrates a block diagram of another non-limiting electronic structure that con be employed at the quantum system of FIG. 1 to provide both readout control and flux control for a coupler qubit of the quantum system of FIG. 1, in accordance with one or more embodiments described herein.

FIG. 4 illustrates a block diagram of still another non-limiting electronic structure that con be employed at the quantum system of FIG. 1 to provide both readout control and flux control for a coupler qubit of the quantum system of FIG. 1, in accordance with one or more embodiments described herein.

FIG. 5 provides a schematic illustration of a non-limiting electronic system that comprises the electronic structure of FIG. 2 or FIG. 3 and that can be employed at the quantum system of FIG. 1, in accordance with one or more embodiments described herein.

FIG. 6 provides a schematic illustration of a non-limiting electronic system that comprises the electronic structure of FIG. 4 and that can be employed at the quantum system of FIG. 1, in accordance with one or more embodiments described herein.

FIG. 7 illustrates a set of features of both a readout portion and a flux control portion of the one or more electronic structures described herein, to allow for ease of comparison thereof, in accordance with one or more embodiments described herein.

FIG. 8 illustrates a process flow for controlling a coupler qubit of a quantum system, in accordance with one or more embodiments described herein.

FIG. 9 illustrates another process flow for controlling a coupler qubit of a quantum system, in accordance with one or more embodiments described herein.

FIG. 10 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Discussion is provided herein relative to configuration, including fabrication, of an electronic structure that provide both readout control and flux control of a coupler qubit of a quantum system. Additionally, as there are many uses for devices providing both readout signals and flux control signals, the discussion herein need not apply solely to quantum computer electronics, but can also apply to many other control, radio, radar, cryogenic and/or signal-based applications, among others. Description and discussion herein are therefore not limited to use in a quantum computing system only.

Turning first to existing frameworks for providing readout control and flux control, e.g., at a quantum system, such processes are provided separately by separate devices. Separate devices require separate input lines and separate hardware real estate, including the real estate for the wires themselves. Real estate can be limited, particularly inside of a cryogenic chamber (e.g., cryostat) of a quantum system. Additional wires and components also can be costly in terms of the noise produced by such hardware, where noise can affect measurement readout or even control of a quantum system, increasing the error of such quantum system.

Accordingly, to account for one or more other deficiencies of existing frameworks, one or more embodiments described herein can provide an electronic structure that can provide, from the same electronic structure, both readout control and flux control of a coupler qubit. In one or more embodiments, such processes can be provided simultaneously. A single input line can be employed, thus reducing wiring as compared to existing frameworks. Further, overall real estate, noise produced, and error caused by existing frameworks can be reduced by use of the one or more embodiments described herein.

In the quantum realm, such electronic structure can be useful in a case where a flux-controlled coupler qubit is used as a tunable coupler. In can be useful to be able to excite or reset the coupler qubit to verify the coupler qubit is in its ground state. That is, a radio frequency (RF) tone can be applied to the coupler qubit to reset, measure or excite the coupler qubit. Likewise, flux of the qubit controller can be controlled via the coupler qubit's flux element, such as a superconducting quantum interference device (SQUID). In another example, it may be desired to perform a reset of a coupler qubit by varying flux while performing another process, such as sweeping the coupler qubit, through a readout line. The one or more embodiments described herein can provide for these processes, as will be detailed below.

Discussion now turns herein to one or more exemplary embodiments described in particular relative to use in a quantum device for operation of a quantum circuit. As used herein, a quantum circuit can be a set of operations, such as for executing one or more gates, performed on a set of real-world physical qubits with the purpose of obtaining one or more qubit measurements. A quantum processor can comprise the one or more real-world physical qubits.

Qubit states only can exist (or can only be coherent) for a limited amount of time. Thus, an objective of operation of a quantum logic circuit (e.g., including one or more qubits) can be to maximize the utilization of the coherence time of the employed qubits. Time spent to operate the quantum logic circuit can undesirably reduce the available time of operation on one or more qubits. This can be due to the available coherence time of the one or more qubits prior to decoherence of the one or more qubits. For example, a qubit state can be lost in less than 100 to 200 microseconds in one or more cases.

Operation of the quantum circuit can be supported, such as by a pulse component (also herein referred to as a waveform generator), to produce one or more physical pulses and/or other waveforms, signals and/or frequencies to alter one or more states of one or more of the physical qubits. The altered states can be measured, thus allowing for one or more computations to be performed regarding the qubits and/or the respective altered states.

Operations on qubits generally can introduce some error, such as some level of decoherence and/or some level of quantum noise, further affecting qubit availability. Quantum noise can refer to noise attributable to the discrete and/or probabilistic natures of quantum interactions.

One or more embodiments are now described with reference to the drawings, where like referenced numerals are used to refer to like elements throughout.

As used herein, the terms “entity”, “requesting entity” and “user entity” can refer to a machine, device, component, hardware, software, smart device and/or human.

As used herein, the term “electronic chip” can refer to, but must not always refer to, a silicon chip. As used herein, the term “silicon chip” can refer to a chip comprising silicon and/or any other material.

In the following description, for purposes of explanation, numerous specific details are set forth in order to provide a more thorough understanding of the one or more embodiments. It is evident, however, in various cases, that the one or more embodiments can be practiced without these specific details.

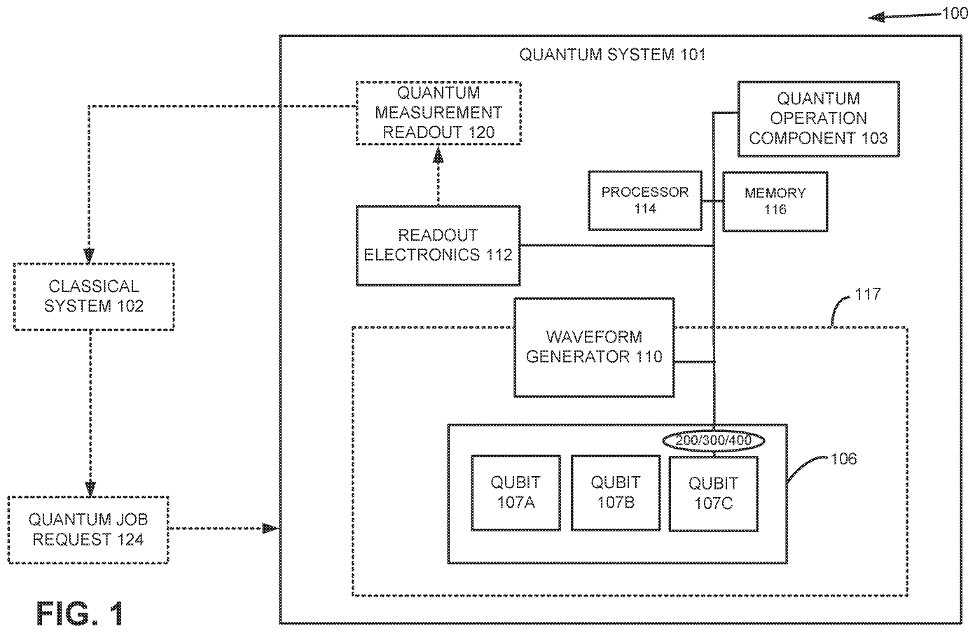

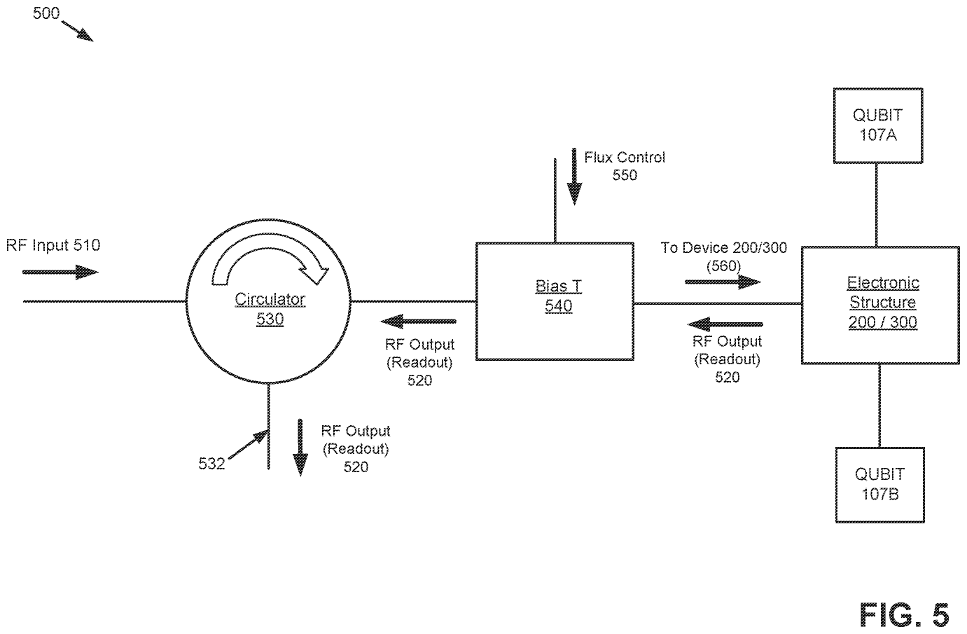

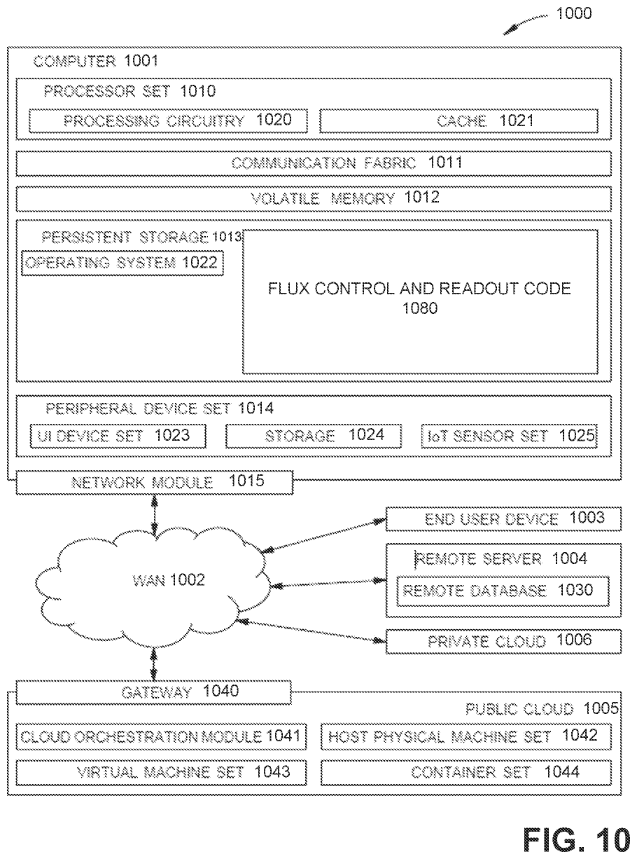

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100, 500 and/or 600 as illustrated at FIGS. 1, 5 and 6, and/or systems thereof, can further comprise, be associated with and/or be coupled to one or more computer and/or computing-based elements described herein with reference to an operating environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1, 5 and/or 6 and/or with other figures described herein.

Turning first generally to FIG. 1, one or more embodiments described herein can include one or more devices, systems and/or apparatuses that can provide a process to generate one or more waveforms for a quantum-based operation (e.g., using a quantum device), such as for operating one or more qubits of a quantum device. Accordingly, at FIG. 1, illustrated is a block diagram of an example, non-limiting system 100 that can at least partially facilitate such a process. While referring here to one or more processes, facilitations and/or uses of the non-limiting system 100, description provided herein, both above and below, also can be relevant to one or more other non-limiting systems described herein, such as the non-limiting system 200, to be described below in detail.

As illustrated at FIG. 1, the non-limiting system 100 can comprise a quantum system 101 that can be employed with or separate from a classical system 102.

Generally, the quantum system 101 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 120, can be responsive to the quantum job request 124 and associated input data and can be based at least in part on the input data, quantum functions and/or quantum computations.

In one or more embodiments, the quantum system 101 can comprise components, such as a quantum operation component 103, a quantum processor 106, pulse component 110 (e.g., a waveform generator) and/or a readout electronics 112 (e.g., readout component). In one or more other embodiments, the readout electronics 112 can be comprised at least partially by the classical system 102 and/or be external to the quantum system 101. The quantum processor 106 can comprise one or more, such as plural, qubits 107. Individual qubits 107A, 107B and 107C, for example, can be fixed frequency and/or single junction qubits, such as transmon qubits.

The quantum processor 106 can be any suitable processor. The quantum processor 106 can generate one or more instructions for controlling the one or more processes of the quantum operation component 103.

The quantum operation component 103 can obtain (e.g., download, receive, search for and/or the like) a quantum job request 124 requesting execution of one or more quantum programs and/or a physical qubit layout. The quantum job request 124 can be provided in any suitable format, jsuch as a text format, binary format and/or another suitable format. In one or more embodiments, the quantum job request 124 can be obtained by a component other than of the quantum system 101, such as a by a component of the classical system 102.

In one or more embodiments, a memory 116 and/or processor 114 can be associated with the quantum operation component 103, where suitable.

The quantum operation component 103 can determine mapping of one or more quantum logic circuits for executing a quantum program. In one or more embodiments, the quantum operation component 103 and/or quantum processor 106 can direct the waveform generator 110 to generate one or more pulses, tones, waveforms and/or the like to affect one or more qubits 107, such as in response to a quantum job request 124.

The waveform generator 110 can generally cause the quantum processor 106 to perform one or more quantum processes, calculations and/or measurements by creating a suitable electro-magnetic signal. For example, the waveform generator 110 can operate one or more qubit effectors, such as qubit oscillators, harmonic oscillators, pulse generators and/or the like to cause one or more pulses to stimulate and/or manipulate the state(s) of the one or more qubits 107 comprised by the quantum system 101.

The quantum processor 106 and a portion or all of the waveform generator 110 can be contained in a cryogenic environment, such as generated by a cryogenic environment 117, such as effected by a dilution refrigerator. Indeed, a signal can be generated by the waveform generator 110 to affect one or more of the plurality of qubits 107. Where the plurality of qubits 107 are superconducting qubits, cryogenic temperatures, such as about 4K or lower, can be employed for function of these physical qubits. Accordingly, one or more elements of the readout electronics 112 also can be constructed to perform at such cryogenic temperatures.

The readout electronics 112, or at least a portion thereof, can be contained in the cryogenic environment 117, such as for reading a state, frequency and/or other characteristic of qubit, excited, decaying or otherwise.

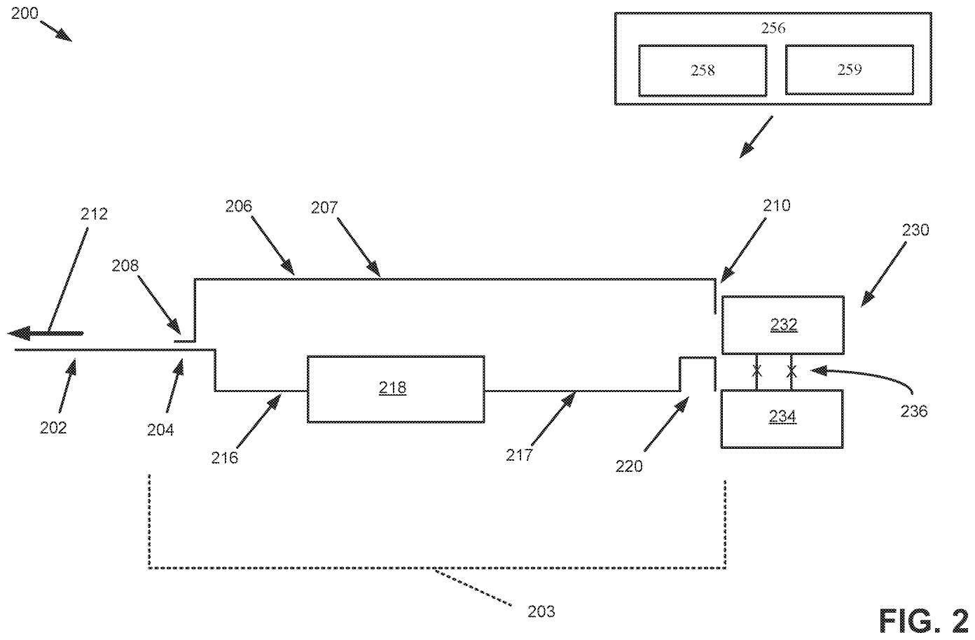

An electronic structure 200/300/400 as described herein, such as relative to any of FIGS. 2-4, to be described below in detail, can be employed to provide both readout control and flux control to a single qubit, e.g., a coupler qubit, such as qubit 107C, by way of a single input line. Indeed, any one or more such devices can be employed in a single quantum system (e.g., quantum system 101).

Further, the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning next to FIG. 2, but applicable to any of the electronic structures 200, 300 and/or 400 of any of FIGS. 2 to 4, in one or more embodiments, one or more operations for fabricating the one or more electronic structures described herein can be performed by a manufacturing system, such as a fabrication system 256 comprising one or more manufacturing devices 258. The fabrication system 256 can be operatively coupled to a processor 259 for at least partially controlling the one or more operations described herein. The processor 259 can be any suitable processor. Discussion provided below with respect to processor set 1010 can be at least partially equally applicable to the processor 259.

In one or more embodiments, the fabrication system 256 can be configured, such as by one or more operations performed by one or more of the manufacturing devices 258 in view of one or more instructions provided by the processor 259, to construct the electronic structure 100, such as relative to and/or on a substrate. The one or more manufacturing devices 258 can, perform, among other operations, one or more depositions (e.g., liner deposition), transfer, etching, cutting, printing, growing, placement, lasering, removal, radiation, irradiation, adhesive operations, metallization operations, welding, electroplating and/or other plating methods, component location and/or fastener attachment.

Still referring to FIG. 2, illustrated is an electronic structure 200 that can be employed with the quantum system 101 for providing both readout control and flux control of a single coupler qubit by way of a single input line. The electronic structure 200 can be disposed on-chip in the quantum processor (e.g., on a same chip comprising a coupler qubit 230) or can be disposed at least partially off-chip.

Generally, the electronic structure 200 comprises a multiplexed input line 202 and a readout and flux control subsystem 203 that control the coupler qubit 230. The multiplexed input line 202 feeds along direction 212 to readout signal and flux control signal input components of a system, e.g., quantum system 101. The readout and flux control subsystem 203 is electrically coupled between the multiplexed input line 202 and a coupler qubit 230. The coupler qubit 230 is tunable due to a flux element 236 disposed between a pair of pads 232, 234 of the coupler qubit 230. As illustrated, the flux element 236 can comprise a pair of Josephson junctions forming a superconducting quantum interference device (SQUID).

In one or more embodiments, the coupler qubit 230 can be coupled to a pair of other qubits of a quantum processor. Tuning of the coupler qubit 230 can adjust coupling between the pair of other qubits (e.g., data qubits).

Turning now to details of the electronic structure 200, both readout signals and flux control signals can be input to the multiplexed input line 202 to allow for transmission to the coupler qubit 230. As illustrated, a readout portion 206 (e.g., first coupler) is configured to transmit the readout signals while a flux control portion 216 (e.g., second coupler) is configured to transmit flux control signals. As shown, the readout portion 206 and flux control portion 206 are separated from one another along their lengths between a diplexer coupling 204 and the coupler qubit 230.

Referring first to the readout portion 206, this portion can comprise a readout resonator 207 that is electrically coupled to the diplexer coupling 204 and to a pad 232 or pad 234 of the coupler qubit 230. In the illustrated embodiment of FIG. 2, the diplexer coupling can be a capacitive coupling where a capacitor pad 208 of the readout portion 206 is coupled to the multiplexed input line 202. It will be appreciated, however, that the readout resonator 207 can have different forms, such as being a lambda/2 (L/2) resonator or a lambda/4 (L/4) resonator. The L/2 resonator can be shorter in length than a L/4 resonator. As illustrated at FIG. 2, the readout resonator 207 is a L/2 resonator having capacitive coupling at both ends. That is, a capacitor pad 210 is coupled to the pad 232 (or alternatively pad 234) of the coupler qubit 230 at one end, with the capacitor pad 208 coupled to the multiplexed input line 202 at the opposite end thereof.

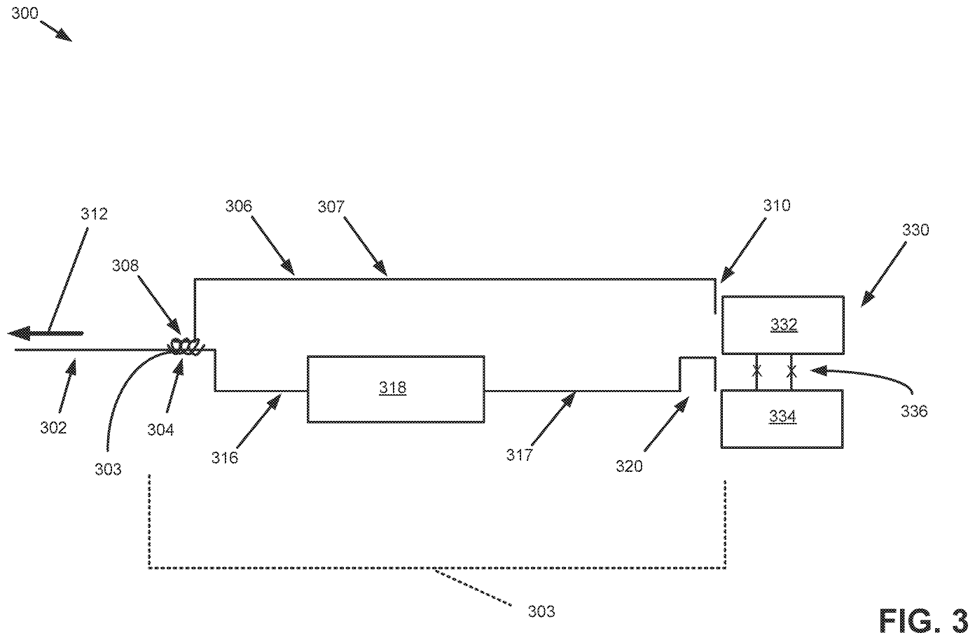

Turning briefly to FIG. 3, illustrated is another embodiment of an electronic structure 300 with element numbers adjusted by 100 to allow for reference to similar elements between the electronic structure 200 and the electronic structure 300. Different from the electronic structure 200, the electronic structure 300 comprises a readout portion 316 that has a L/4 readout resonator 307, and thus is galvanically coupled (e.g., inductively coupled) to the multiplexed input line 202 by a galvanic diplexer coupling 304 comprising an inductance element 303. Note that the readout resonator 307 still is capacitively coupled via capacitor pad 310 to a pad 332 of the coupler qubit 330.

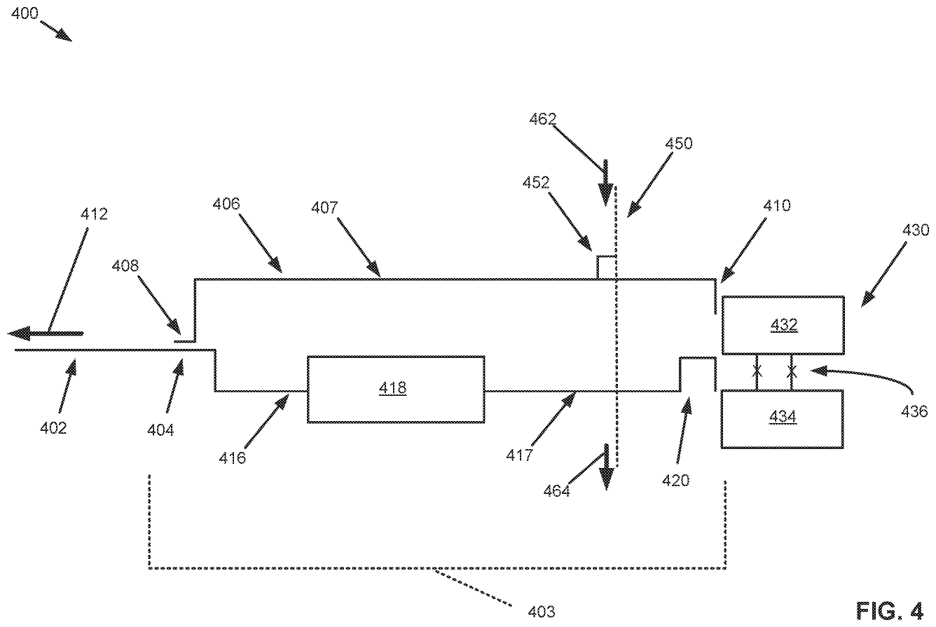

Turning next to FIG. 4, illustrated is yet another embodiment of an electronic structure 400 with element numbers adjusted by 100, relative to the electronic structure 300, and adjusted by 200, relative to the electronic structure 200, to allow for reference to similar elements between the electronic structure 200 and the electronic structure 300. Different from the electronic structure 200 and the electronic structure 300, the electronic structure 400 comprises Purcell filter 450 that is coupled to the readout resonator 407 by a coupler 452. Use of the Purcell filter can allow for a more rapid readout that can be facilitated by transmission along the multiplexed input line 402 and along the readout portion 406. Also, it is appreciated that while the readout resonator 407 is depicted as an L/2 resonator with capacitive coupling, the readout resonator 407, in one or more other embodiments, can be an L/4 resonator with galvanic coupling to the multiplexed input line 202.

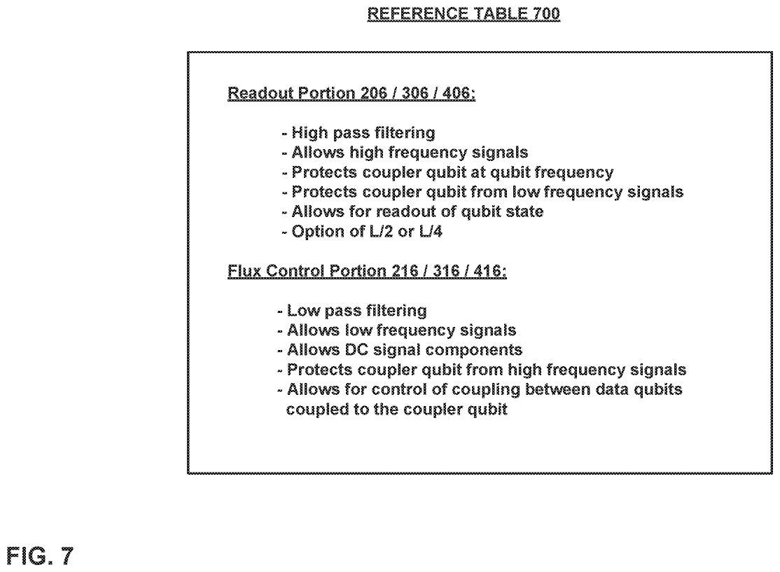

Each of the readout resonators 207, 307 and 407 forms a circuit quantum electro dynamics (QED) scheme for controlling the respective coupler qubits 230, 330, and 430. This path of the respective electronic structures 200, 300, and 400 filters any signal received at the multiplexed input lines 202, 302, 402 allowing for only high frequency signal components to be transmitted through the readout resonators 207, 307 and 407 to the respective coupler qubits 230, 330, and 430. That is, turning briefly to FIG. 7, the readout resonators 207, 307 and 407 can protect the coupler qubits 230, 330 and 430 at their respective qubit frequencies and from low frequency signals that are instead filtered out. As used herein, a qubit frequency is a lowest oscillating frequency of a non-linear resonator, where the readout resonator 207, 307, 407 acts as a filter that limits and/or altogether prevents noise from the multiplexed input line 202, 302, 402 from interfering with the coupler qubit 230, 330, 430. This can allow for readout of a qubit state of the coupler qubits 230, 330, 430 by the quantum system coupled thereto (e.g., by the readout component 112 of the quantum system 101).

Turning now back to FIG. 2 and to the flux control portion 216, description provided can be applied to both the flux control portion 306 and the flux control portion 416 of the respective electronic structures 300 and 400. As illustrated at FIG. 2, the flux control portion 206 can comprise a wire 217 that is coupled to the diplexer coupling 204, such as directly and/or the wire 217 and multiplexed input line 202 being a same line. Opposite the diplexer coupling 204, the flux control portion 216 is electrically coupled to the flux element 236 of the coupler qubit 230 by a flux coupler 220. The flux coupler 220 can comprise a loop and/or transformer. The flux control portion 216 further comprises a filter, e.g., a flux coupler filter 218. This flux coupler filter 218 can be configured (e.g., constructed, via the materials therein) to provide low pass filtering, allowing for only low frequency signals and DC signal components to be transmitted through the flux coupler filter 218. In one or more embodiments, the flux coupler filter 218 can comprise two inductors and a capacitor. In one or more embodiments, the flux coupler filter 218 can be multi-pole, although a single-pole filter can be suitable. That is, referring briefly to FIG. 7, the flux control portion 216 allows for transmission of flux control signals to the flux element 236 (e.g., SQUID) of the coupler qubit 230 without high frequency components, to allow for control of coupling between qubits (e.g., data qubits) coupled to the coupler qubit.

Referring next to FIG. 5, one or more additional components of a control subsystem 500 can be electrically coupled between the electronic structure 200, 300 or 400 and the readout/flux input signal components of the respective quantum system. That is, reference will be made to the electronic structure 200 but is also applicable to the electronic structures 300 and 400.

A bias-tee (bias T) 540 can allow for three-way coupling between the electronic structure 200, flux control element and readout control element (e.g., readout component 112). That is, due to the construction of the bias T 540, flux control signals 550 will not be transmitted towards the readout control element but instead will only pass to the electronic structure 200, to then be transmitted along the flux control portion 216. Likewise, any readout signals (e.g., RF output 520) reflected from the coupler qubit 230 and directed back through the readout portion 206 of the electronic structure 200 will not pass to the flux control element (e.g., current source) due to the bias T 540.

A circulator 530 provides for passive switching between RF input signals 510 transmitted to the electronic structure 200 and RF output signals 520 transmitted from the coupler qubit 230 (e.g., directed back towards the RF input component). That is, an RF input signal 510 will be prevented by the circulator 530 from exiting the circulator 530 along the RF output line 532.

In one or more other embodiments, a circuit can be employed, in place of the circulator 530, that acts as a ferromagnetic circulator using Josephson elements, although such elements require pumping and are not passive as is the circulator 530. That is, such one or more other embodiments refer to active switching between RF input signals 510 transmitted to the electronic structure 200 and RF output signals 520 transmitted from the coupler qubit 230 (e.g., directed back towards the RF input component).

The control subsystem 500 allows for operation of dispersive readout. During operation, an RF input signal 510 will be directed through the circulator 530, through the bias T 540 and towards the electronic structure 200 along the direction 560. If the coupler qubit 230 is in its ground state, the RF input signal 510 will be absorbed by the coupler qubit 230. Alternatively, if the coupler qubit 230 is in a higher excited state (e.g., other than the ground state), the RF input signal 510 will be reflected as an RF output signal 520 and will be reflected back along the readout portion 206, through the bias T 540, and through the circulator to the RF output line 532.

In one or more other embodiments, a circuit can be employed that comprises active mixers to shift frequencies of signals received.

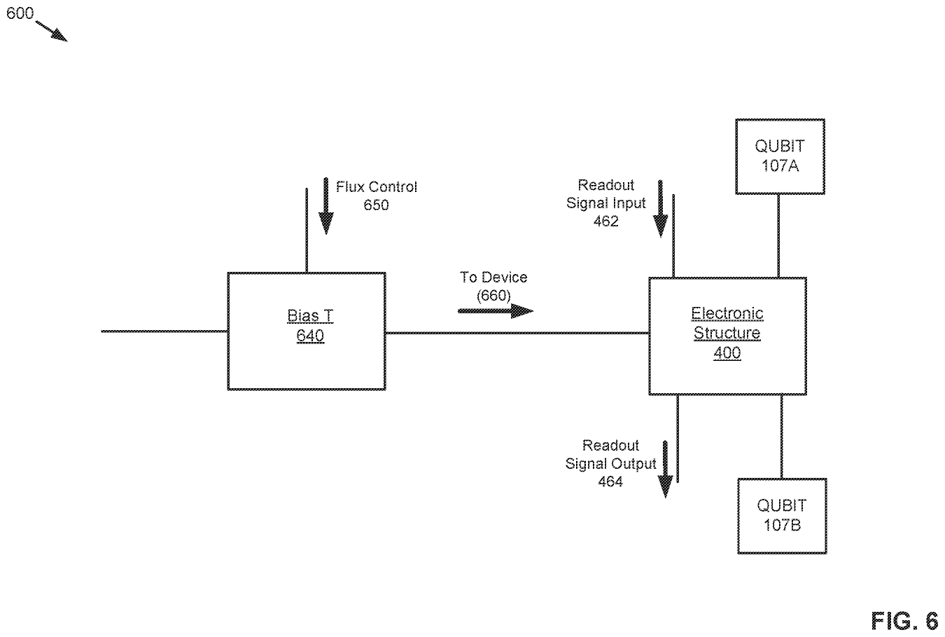

Turning next to FIG. 6, where the electronic structure (e.g., specifically, electronic structure 400) comprises a Purcell filter, the circulator can be not necessary. Although, in one or more other embodiments, a circulator still can be employed to allow for both readout along the readout portion of the respective electronic structure and along a Purcell filter of the electronic structure. As depicted at FIG. 6, the circulator is omitted from the control subsystem 600. Instead, readout signal input 462 (e.g., RF input) can be passed along the Purcell filter 450 (FIG. 4) and readout signal output 464 can be transmitted from the Purcell filter 450.

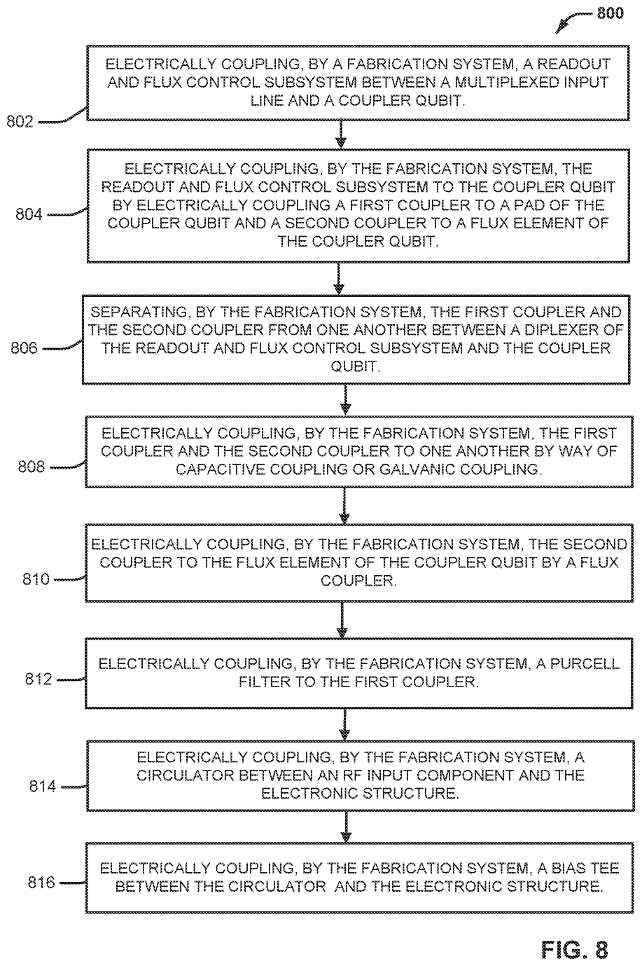

Next, in additional summary, FIG. 8 illustrates a flow diagram of an example, non-limiting method 800 that can provide processes of fabrication of an electronic structure that can provide both readout control and flux control to a coupler qubit, such as of a quantum system, in accordance with one or more embodiments described herein, such as the non-limiting electronic structure 200 of FIG. 2. While the non-limiting method 800 is described relative to the non-limiting electronic structure 200 of FIG. 2, the non-limiting method 800 can be applicable also to other electronic structures and/or electronic systems described herein, such as described at FIGS. 3-6. Repetitive description of like elements and/or processes employed in respective embodiments is omitted for sake of brevity.

At 802, the non-limiting method 800 can comprise electrically coupling, by a fabrication system (e.g., fabrication system 256), a readout and flux control subsystem between a multiplexed input line and a coupler qubit (e.g., qubit 107C).

At 804, the non-limiting method 800 can comprise electrically coupling, by the fabrication system (e.g., fabrication system 256), the readout and flux control subsystem to the coupler qubit by electrically coupling a first coupler (e.g., readout portion 206) to a pad (e.g., pad 232 or 234) of the coupler qubit and a second coupler (e.g., flux control portion 216) to a flux element (e.g., flux element 236) of the coupler qubit.

At 806, the non-limiting method 800 can comprise separating, by the fabrication system (e.g., fabrication system 256), the first coupler and the second coupler from one another between a diplexer (e.g., diplexer coupling 204) of the readout and flux control subsystem and the coupler qubit.

At 808, the non-limiting method 800 can comprise electrically coupling, by the fabrication system (e.g., fabrication system 256), the first coupler and the second coupler to one another by way of capacitive coupling or galvanic coupling (e.g., inductive coupling).

At 810, the non-limiting method 800 can comprise electrically coupling, by the fabrication system (e.g., fabrication system 256), the second coupler (e.g., flux control portion 216) to the flux element of the coupler qubit by a flux coupler (e.g., flux coupler 220).

At 812, the non-limiting method 800 can comprise electrically coupling, by the fabrication system (e.g., fabrication system 256), a Purcell filter (e.g., Purcell filter 450) to the first coupler (e.g., readout portion 206).

At 814, the non-limiting method 800 can comprise electrically coupling, by the fabrication system (e.g., fabrication system 256), a circulator (e.g., circulator 530) between an RF input component and the electronic structure.

At 816, the non-limiting method 800 can comprise electrically coupling, by the fabrication system (e.g., fabrication system 256), a bias tee (e.g., bias tee 540) between the circulator (e.g., circulator 530) and the electronic structure.

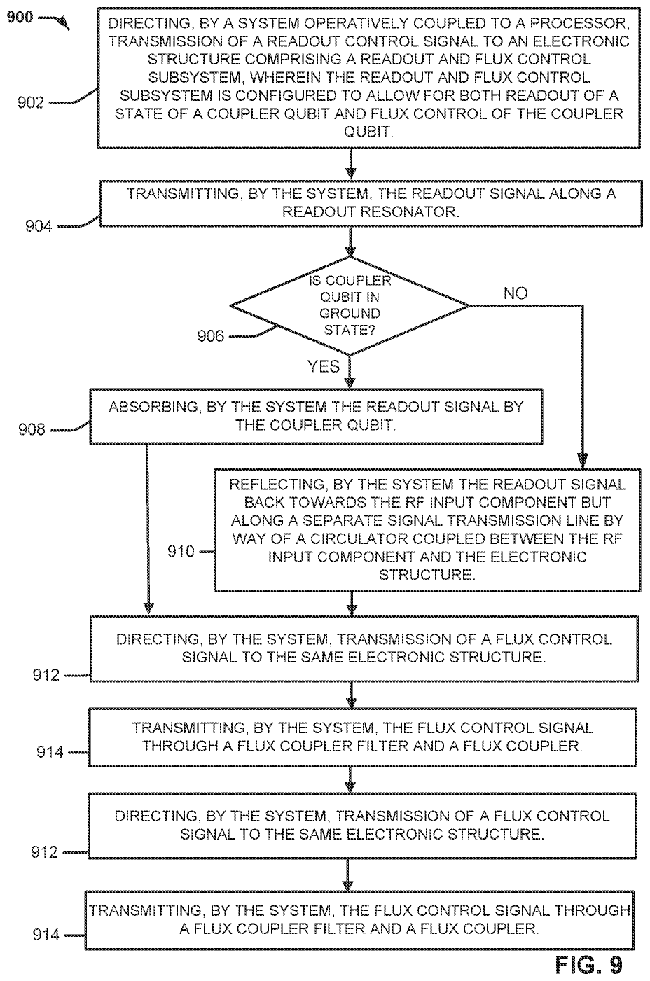

As further summary, FIG. 9 illustrates a flow diagram of an example, non-limiting method 900 that can provide processes of readout control and flux control to a coupler qubit, such as of a quantum system, in accordance with one or more embodiments described herein, such as the non-limiting electronic structure 200 of FIG. 2. While the non-limiting method 900 is described relative to the non-limiting electronic structure 200 of FIG. 2, the non-limiting method 900 can be applicable also to other electronic structures and/or electronic systems described herein, such as described at FIGS. 3-6. Repetitive description of like elements and/or processes employed in respective embodiments is omitted for sake of brevity.

At 902, the non-limiting method 900 can comprise directing, by a system operatively coupled to a processor (e.g., quantum operation component 103 of quantum system 101), transmission of a readout control signal to an electronic structure (e.g., electronic structure 200) comprising a readout and flux control subsystem, wherein the readout and flux control subsystem is configured to allow for both readout of a state of a coupler qubit (e.g., qubit 107C) and flux control of the coupler qubit.

At 904, the non-limiting method 900 can comprise transmitting, by the system (e.g., readout portion 206), the readout signal along a readout resonator (e.g., readout resonator 207).

Depending on whether the coupler qubit is at its ground state (e.g., at 906), the non-limiting method 900 can comprise absorbing, at 908, by the system (e.g., by the coupler qubit) the readout signal by the coupler qubit where the coupler qubit is in its ground state, or, the non-limiting method 900 can comprise reflecting, at 910, by the system (e.g., by the coupler qubit) the readout signal back towards the RF input component but along a separate signal transmission line by way of a circulator (e.g., circulator 530) coupled between the RF input component and the electronic structure (e.g., electronic structure 200).

At 912, the non-limiting method 900 can comprise directing, by the system (e.g., quantum operation component 103 of quantum system 101), transmission of a flux control signal to the same electronic structure (e.g., electronic structure 200).

At 914, the non-limiting method 900 can comprise transmitting, by the system (e.g., flux control portion 216), the flux control signal through a flux coupler filter (e.g., flux coupler filter 218) and a flux coupler (e.g., flux coupler 220).

At 916, the non-limiting method 900 can comprise adjusting, by the system (e.g., flux control portion 216), a state of the coupler qubit by receipt of the flux control signal at a flux element (e.g., flux element 236) of the coupler qubit.

At 918, the non-limiting method 900 can comprise alternatively directing, by the system (e.g., quantum operation component 103 of quantum system 101), transmission of the readout signal along a Purcell filter electrically coupled to the readout portion (e.g., readout portion 206).

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

Where description indicates a process as taking place at a classical system or a quantum system, it is noted that in one or more other embodiments, such process can take place, at least partially, at the other of the classical system or the quantum system, where suitable and/or where such other system is configured to perform the process.

In summary, one or more systems, devices and/or computer-implemented methods of use provided herein relate to single-device readout of the state of a coupler qubit and flux control of that coupler qubit, which processes can be performed simultaneously. In one or more embodiments, an electronic system comprises a coupler qubit, a pair of superconducting qubits coupled to the coupler qubit, a multiplexed input line, and a readout and flux control subsystem coupled between the multiplexed input line and the coupler qubit, wherein the readout and flux control subsystem is configured to allow for both readout of a state of the coupler qubit and flux control that adjusts a coupling between the pair of superconducting qubits. The diplexer couples together the readout resonator and a flux control portion of the electronic system, wherein the readout resonator and the flux control portion are separated from one another between the diplexer and the coupler qubit.

An advantage of any one or more of the above-indicated embodiments can be an ability to both provide for qubit readout and qubit flux control with a single device. In one or more cases, where applicable, these processes can be performed simultaneously. By providing both processes with a single electronic structure, valuable real estate can be saved in a cryogenic environment where this electronic structure is located, along with the physical qubits of a quantum processor. That is, a single electronic structure can provide both the qubit readout and the qubit flux control. A single input line can then be used for both the qubit readout and the qubit flux control, allowing for reduced wiring into a cryogenic environment, where wires and couplers take up valuable real estate.

Indeed, in view of the one or more embodiments described herein, a practical application of the systems, computer-implemented methods and/or computer program products described herein can be ability to provide a pair of processes for operation of a quantum system with a single electronic structure, which co-operation is not possible with existing electronic structures. This can result in reduced part count, cost, manufacturing time, and/or use of real estate in a quantum cryogenic chamber (e.g., cryostat).

Furthermore, one or more embodiments described herein can be employed in a real-world system based on the disclosed teachings. For example, one or more embodiments described herein can function as part of a quantum system that can receive as input a quantum job request comprising a quantum source code for execution comprising one or more operations as described herein, and that can measure a real-world qubit state of one or more qubits, such as superconducting qubits, of the quantum system, by executing the quantum source code at some level of the quantum system. Indeed, the one or more embodiments described herein can be employed to measure the real-world qubit state.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to quantum circuit execution, and/or to qubit control more generally, as compared to existing systems and/or techniques. Systems, computer-implemented methods and/or computer program products providing performance of these processes are of great utility in the fields of quantum circuit operation and/or qubit control more generally and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically measure a state of a coupler qubit and/or apply a control flux to the coupler qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

An electronic structure comprising: an input line electrically coupled to a first coupler and a second coupler; a flux-controlled qubit comprising a flux element; the first coupler electrically coupled to a pad of the flux-controlled qubit; and the second coupler electrically coupled to the flux element of the flux-controlled qubit.

The electronic structure of the preceding claim, wherein the flux element comprises a SQUID.

The electronic structure of any preceding claim, wherein the first coupler is capacitively coupled to the input line.

The electronic structure of any preceding claim, wherein the second coupler is galvanically coupled to the input line.

The electronic structure of any preceding claim, wherein the first coupler comprises a lambda/2 or lambda/4 readout resonator.

The electronic structure of any preceding claim, wherein the second coupler comprises a filter.

An electronic system, comprising: a multiplexed input line; and a readout and flux control subsystem coupled between the multiplexed input line and the coupler qubit, wherein the readout and flux control subsystem is configured to allow for both readout of a state of a coupler qubit and flux control of the coupler qubit.

The electronic system of the preceding claim, wherein the readout and flux control subsystem comprises a diplexer, a readout resonator and a flux filter.

The electronic system of any preceding claim, wherein the readout and flux control subsystem comprises wiring configured to withstand cryogenic temperatures.

The electronic system of any preceding claim, wherein the diplexer couples together the readout resonator and a flux control portion of the electronic system, and wherein the readout resonator and the flux control portion are separated from one another between the diplexer and the coupler qubit.

The electronic system of any preceding claim, wherein the electronic system is configured to simultaneously allow for the readout of the state of the coupler qubit and the flux control of the coupler qubit.

The electronic system of any preceding claim, further comprising: a circulator that is switchable between allowing RF input to the coupler qubit and allowing RF output from the coupler qubit.

The electronic system of any preceding claim, further comprising: a Purcell filter coupled to the readout resonator.

An electronic structure, comprising: a coupler qubit; a pair of superconducting qubits coupled to the coupler qubit; a multiplexed input line; and a readout and flux control subsystem coupled between the multiplexed input line and the coupler qubit, wherein the readout and flux control subsystem is configured to allow for both readout of a state of the coupler qubit and flux control that adjusts a coupling between the pair of superconducting qubits.

The electronic system of the preceding claim, wherein the readout and flux control subsystem comprises a diplexer, a readout resonator and a flux filter.

The electronic system of any preceding claim, wherein the readout and flux control subsystem comprises wiring configured to withstand cryogenic temperatures.

The electronic system of any preceding claim, wherein the diplexer couples together the readout resonator and a flux control portion of the electronic system, and wherein the readout resonator and the flux control portion are separated from one another between the diplexer and the coupler qubit.

The electronic system of any preceding claim, wherein the electronic system is configured to simultaneously allow for the readout of the state of the coupler qubit and the flux control that adjusts the coupling between the pair of superconducting qubits.

The electronic system of any preceding claim, further comprising.
a circulator that is switchable between allowing RF input to the coupler qubit and allowing RF output from the coupler qubit.

The electronic system of any preceding claim, further comprising: a Purcell filter coupled to the readout resonator.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the flux control and readout code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction paths that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A electronic structure comprising:
an input line electrically coupled to a first coupler and a second coupler;
a flux controlled qubit comprising a flux element;
the first coupler electrically coupled to a pad of the flux controlled qubit; and
the second coupler electrically coupled to the flux element of the flux controlled qubit.

2. The electronic structure of claim 1, wherein the flux element comprises a SQUID.

3. The electronic structure of claim 1, wherein the first coupler is capacitively coupled to the input line.

4. The electronic structure of claim 1, wherein the second coupler is galvanically coupled to the input line.

5. The electronic structure of claim 1, wherein the first coupler comprises a lambda/2 or lambda/4 readout resonator.

6. The electronic structure of claim 1, wherein the second coupler comprises a filter.

7. An electronic system, comprising:
a multiplexed input line; and
a readout and flux control subsystem coupled between the multiplexed input line and the coupler qubit,
wherein the readout and flux control subsystem is configured to allow for both readout of a state of a coupler qubit and flux control of the coupler qubit.

8. The electronic system of claim 7, wherein the readout and flux control subsystem comprises a diplexer, a readout resonator and a flux filter.

9. The electronic system of claim 7, wherein the readout and flux control subsystem comprises wiring configured to withstand cryogenic temperatures.

10. The electronic system of claim 8, wherein the diplexer couples together the readout resonator and a flux control portion of the electronic system, and wherein the readout resonator and the flux control portion are separated from one another between the diplexer and the coupler qubit.

11. The electronic system of claim 7, wherein the electronic system is configured to simultaneously allow for the readout of the state of the coupler qubit and the flux control of the coupler qubit.

12. The electronic system of claim 1, further comprising:
a circulator that is switchable between allowing RF input to the coupler qubit and allowing RF output from the coupler qubit.

13. The electronic system of claim 8, further comprising:
a Purcell filter coupled to the readout resonator.

14. An electronic system, comprising:
a coupler qubit;
a pair of superconducting qubits coupled to the coupler qubit;
a multiplexed input line; and
a readout and flux control subsystem coupled between the multiplexed input line and the coupler qubit,
wherein the readout and flux control subsystem is configured to allow for both readout of a state of the coupler qubit and flux control that adjusts a coupling between the pair of superconducting qubits.

15. The electronic system of claim 14, wherein the readout and flux control subsystem comprises a diplexer, a readout resonator and a flux filter.

16. The electronic system of claim 14, wherein the readout and flux control subsystem comprises wiring configured to withstand cryogenic temperatures.

17. The electronic system of claim 15, wherein the diplexer couples together the readout resonator and a flux control portion of the electronic system, and wherein the readout resonator and the flux control portion are separated from one another between the diplexer and the coupler qubit.

18. The electronic system of claim 14, wherein the electronic system is configured to simultaneously allow for the readout of the state of the coupler qubit and the flux control that adjusts the coupling between the pair of superconducting qubits.

19. The electronic system of claim 14, further comprising:
a circulator that is switchable between allowing RF input to the coupler qubit and allowing RF output from the coupler qubit.

20. The electronic system of claim 15, further comprising:
a Purcell filter coupled to the readout resonator.
